(19) United States
(12) Patent Application Publication
(10) Pub. No.: US 2011/0137681 A1
(43) Pub. Date: Jun. 9, 2011

(54) SYSTEM FOR MANAGING PERSONAL HEALTH DEVICE MEASUREMENT DATA BASED ON HL7 CDA STANDARD

(75) Inventors: Joon Ho Lim, Daejeon (KR); Chan Yong Park, Daejeon (KR); Soo Jun Park, Seoul (KR); Seon Hee Park, Daejeon (KR)

(73) Assignee: Electronics and Telecommunications Research Institute, Daejeon (KR)

(21) Appl. No.: 12/959,152

(22) Filed: Dec. 2, 2010

(30) Foreign Application Priority Data
Dec. 4, 2009 (KR) 10-2009-0119666

(51) Int. Cl. G06Q 50/00; G06Q 10/00

(52) U.S. Cl. 705/3

(57) ABSTRACT

A system for managing personal health device measurement data based on the HL7 CDA (Clinical Document Architecture) standard includes: a reception unit receiving a device CDA from a health gateway; a CDA analyzing unit analyzing the device CDA delivered from the reception unit to extract header information and health measurement information; a user/device database (DB) storing the header information which has been extracted by the CDA analyzing unit; and a personal health record (PHR) DB storing the health measurement information which has been extracted by the CDA analyzing unit.

### CROSS-REFERENCE TO RELATED APPLICATIONS

This application claims the priority of Korean Patent Application No. 10-2009-0119666 filed on Dec. 4, 2009 in the Korean Intellectual Property Office, the disclosure of which is incorporated herein by reference.

### BACKGROUND OF THE INVENTION

1. Field of the Invention

The present invention relates to a system for managing personal health device measurement data based on the HL7 CDA (Clinical Document Architecture) standard and, more particularly, to a system for analyzing personal health data which has been measured according to an ISO/IEEE 11073 PHD (Personal Health Device) international standard and then converted into the HL7 CDA format, to extract header information and health measurement information, effectively storing the various types of extracted information in a database (DB), retrieving information from the DB according to a health history request received from an external source, configuring a health history CDA using the retrieved information, and providing the same.

2. Description of the Related Art

Conventional healthcare devices use a data format and a communication method individually defined by each vendor, so therefore, healthcare devices manufactured by different vendors are not compatible with each other.

Thus, an ISO/IEEE 11073 PHD (Personal Health Device) international standard (hereinafter, referred to as a ‘PHD standard’) was stipulated in order to overcome the incompatibility between healthcare devices and provide interoperability between healthcare devices manufactured by different vendors.

Thus, personal health devices measure users' health related data and transmit the measurement data to a health gateway according to the PHD standard, the health gateway converts the received measurement data into the HL7 CDA format.

However, a technique for extracting required information from the HL7 CDA document, which has been converted by the health gateway, and effectively storing and managing the extracted information is yet to exist.

In addition, in order to provide various health care services by using the HL7 CDA information which has been converted by the health gateway, a technique for effectively retrieving data which has been measured a plurality of times by a plurality of personal health devices from a database, configuring the retrieval results as a single HL7 CDA document, and delivering it to a healthcare service is required.

### SUMMARY OF THE INVENTION

An aspect of the present invention provides a system for managing personal health device measurement data based on the HL7 CDA (Clinical Document Architecture) standard capable of analyzing personal health data which has been measured according to a PHD standard and then converted into the HL7 CDA format, to extract header information and health measurement information, effectively storing the various types of extracted information in a database (DB), retrieving information from the DB according to a health history request received from an external source, configuring a health history CDA using the retrieved information, and providing the same.

According to an aspect of the present invention, there is provided a system for managing personal health device measurement data based on the HL7 CDA standard, including: a reception unit receiving a device CDA from a health gateway; a CDA analyzing unit analyzing the device CDA delivered from the reception unit to extract header information and health measurement information; a user/device database (DB) storing the header information which has been extracted by the CDA analyzing unit; and a personal health record (PHR) DB storing the health measurement information which has been extracted by the CDA analyzing unit. The system may further include: a health history check request processing unit searching the user/device DB and the PHR DB according to a health history request received from the exterior; a CDA merging unit configuring a health history CDA document by using search results delivered from the health history check request processing unit; and a transmission unit providing the health history CDA which has been configured by the CDA merging unit to the exterior.

The device CDA may be personal health data which has been measured according to an ISO/IEEE 11073 PHD (Personal Health Device) international standard by a personal health device and then converted into the HL7 CDA format, which includes data measured once by one personal health device.

The CDA analyzing unit may extract header information from computer processing blocks of a header and an entry of the device CDA and then extract the health measurement information.

The header information may include user information and device information.

The health measurement information may be divided into numeric data expressed as a numeric value, enumeration data expressing an event, and an RT-SA (RealTime-SampleArray) data expressing waveform data according to measurement data by a personal health device.

The user/device DB may store the header information in the format of a user information table, a device information table, and a device attribute information table.

The user information table may include any one or more of a USER_ID column storing a user ID, a GENDER column storing the gender of a user, a GIVENNAME column storing a user's name, a FAMILYNAME column storing a user's family name, an ADDRESS column storing a user's address, a HOME_PHONE column storing a user's phone number, a MOBILE_PHONE column storing a user's mobile phone number, and a BIRTH_TIME column storing a user's birth date.

The device information table may include any one or more of a DEVICE_ID column storing an ID of a personal health device, a MODEL_NAME column storing a model name of a maker of the personal health device, a SCOPING ENTITY column storing a scoping entity tag, a DATE SUPPLY column storing an effective time tag, and a CODE column storing a code attribute of a code tag of the personal health device.

The device attribute information table may include any one or more of a DEV_ATTR_KEY column storing a key value of measurement data stored in the PHR DB, a CODE column storing a code attribute of a code tag of observation, a VALUE column storing measurement data, and a UNIT column storing the unit of the measurement data.

The PHR DB may store the health measurement information in the format of a PHR information table.

The PHR information table may include any one or more of a USER_ID column storing a user ID of a device CDA, a DEVICE_ID column storing an ID of a personal health device, a CODE column storing the type of measurement data, an EFFECTIVE_TIME column storing a measurement time, a VALUE column storing measurement data, a UNIT column storing the unit of the measurement data, and a DEV_ATTR_KEY column storing a specific ID for a device attributer information table.

In the PHR information table, data of every column excluding the DEV_ATTR_KEY column may be input as the numeric data among the health measurement information, data of the columns excluding the VALUE column, the UNIT column, and the DEV_ATTR_KEY column may be input as the enumeration data, and data of every column excluding the UNIT column may be input as the RT-SA data.

In the PHR information table, the accuracy and sampling frequency of the personal health device may be expressed through the device attribute information table by using the DEV_ATTR_KEY column.

The health history check request processing unit may generate an SQL (Structured Query Language) statement on the basis of health history check request data received from an external source and search the user device DB and the PHR DB.

The health history check request data may include any one or more of a user ID, a device ID, a start time, an end time, and a measurement data type item.

The CDA merging unit may configure a recordTarget tag by using user information retrieved from the user/device DB, reconfigure a medical equipment block by using device information retrieved from the user/device DB, and dynamically generate a narrative block of the medical equipment block on the basis of the reconfigured content.

When the health measurement information retrieved from the PHR DB has a value and unit value, the CDA merging unit may reconfigure a numeric block, when the health measurement information retrieved from the PHR DB does not have the value and unit value, the CDA merging unit may reconfigure an enumeration block, and when the value is an arrangement of values, the CDA merging unit may reconfigure an RT-SA block.

The health history CDA configured by the CDA merging unit may include data measured several times by a plurality of personal health devices.

The CDA merging unit may collect data which has been measured at the same time by personal health devices and configure the same as a bundle of a plurality of components in a single entry, arrange a plurality of entries configured by collecting data measured at the same time with respect to respective personal health devices in order of measurement time to configure an entry column, arrange entry columns configured by personal health device in random order, and dynamically generate a narrative block with respect to a vital sign section on the basis of content of the entry column, thus configuring the health history CDA.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a system for managing personal health device measurement data based on the HL7 CDA standard according to an exemplary embodiment of the present invention;

FIG. 2 illustrates an example of user information among header information extracted from the HL7 CDA document according to an exemplary embodiment of the present invention;

FIG. 3 illustrates an example of device information among header information extracted from the HL7 CDA document according to an exemplary embodiment of the present invention;

FIG. 4 illustrates an example of device supplementary information among header information extracted from the HL7 CDA document according to an exemplary embodiment of the present invention;

FIG. 5 illustrates an example of numeric data among health measurement information extracted from the HL7 CDA document according to an exemplary embodiment of the present invention;

FIG. 6 illustrates an example of enumeration data among health measurement information extracted from the HL7 CDA document according to an exemplary embodiment of the present invention;

FIG. 7 illustrates an example of RT-SA data among health measurement information extracted from the HL7 CDA document according to an exemplary embodiment of the present invention; and

FIG. 8 illustrates an example of a health history CDA configured according to an exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

When a component is mentioned as being “connected” to or “accessing” another component, this may mean that it is directly connected to or accessing the other component, but it is to be understood that another component may exist therebetween. Also, unless explicitly described to the contrary, the word “comprise” and variations such as “comprises” or “comprising,” will be understood to imply the inclusion of stated elements but not the exclusion of any other elements.

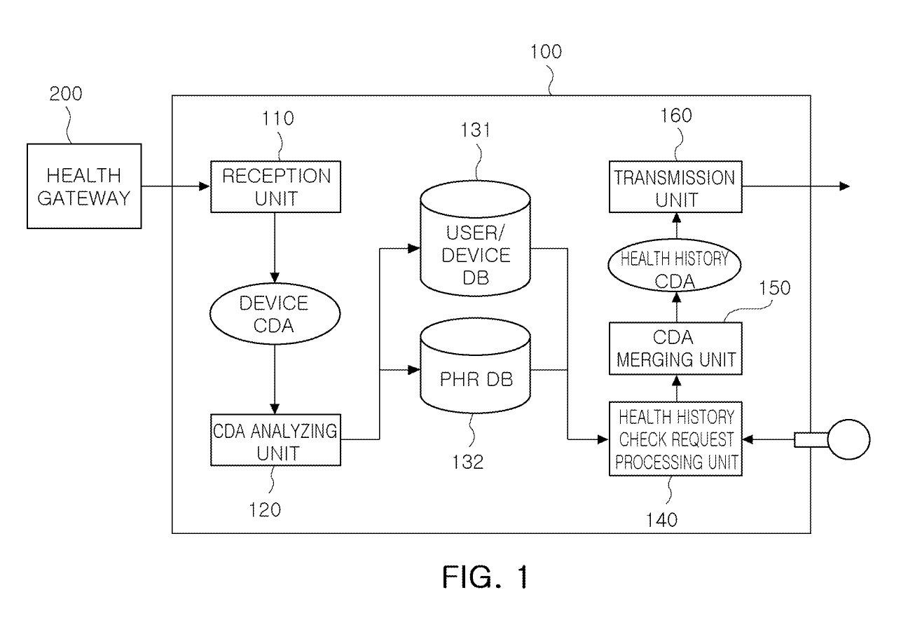

FIG. 1 is a schematic block diagram of a system for managing personal health device measurement data based on HL7 CDA standard according to an exemplary embodiment of the present invention.

With reference to FIG. 1, a system 100 for managing personal health device measurement data according to an exemplary embodiment of the present invention includes a reception unit 110 receiving a CDA document which corresponds to personal health data from a health gateway 200, a CDA analyzing unit 120 analyzing the CDA document received from the reception unit 110 to extract header information and health measurement information, a user/device DB 131 and a PHR DB 132 storing the header information and health measurement information extracted by the CDA analyzing unit 120, respectively, a health history check request processing unit 140 searching the user/device DB 131 and the PHR DB 132 according to a health history request received from the exterior and delivering searched information to a CDA merging unit 150, the CDA merging unit configuring a health history CDA document by using the information delivered from the health history check request processing unit 140, and a transmission unit 160 providing the health history CDA document, which has been configured by the CDA merging unit 150, to the exterior.

The elements of the system 100 for managing personal health device measurement data will now be described in detail.

The reception unit 11 (referred to as a ‘device CDA’, hereinafter) receives personal health data, which has been measured according to a PHD standard by a personal health device (not shown) and converted into the HL7 CDA format, from a health gateway 200. Here, the device CDA includes data measured once by a personal health device. The reception unit 110 may receive the device CDA from the health gateway 200 by using various communication protocols such as a TCIP/IP, MSMQ (Microsoft Message Queuing), a Web service, and the like.

Here, the health gateway 200 may be installed the home of a user who uses a personal health device, a hospital, a retirement village, or the like, to collect user's health data measured by the personal health device. The collecting of the health data by the health gateway 200 is made according to the PHD standard, and the health gateway 200 converts the collected health data according to the HL7 CDA standard. Here, a detailed description of the data collecting and format converting will be omitted.

The CDA analyzing unit 120 analyzes the device CDA delivered from the reception unit 110, extracts header information included in the device CDA, and then extracts health measurement information. In this case, the CDA analyzing unit 120 extracts required information from computer processing blocks such as a header, an entry, and the like, of the device CDA document, but does not extract data of a narrative block using a text tag (<text>).

The information extracted by the CDA analyzing unit 120 is divided into header information and health measurement information. The header information may include user information and device information, and the health measurement information may be divided into numeric data, enumeration data, and RT-SA (RealTime-SampleArray) data. Extracted content according to data types is as follows.

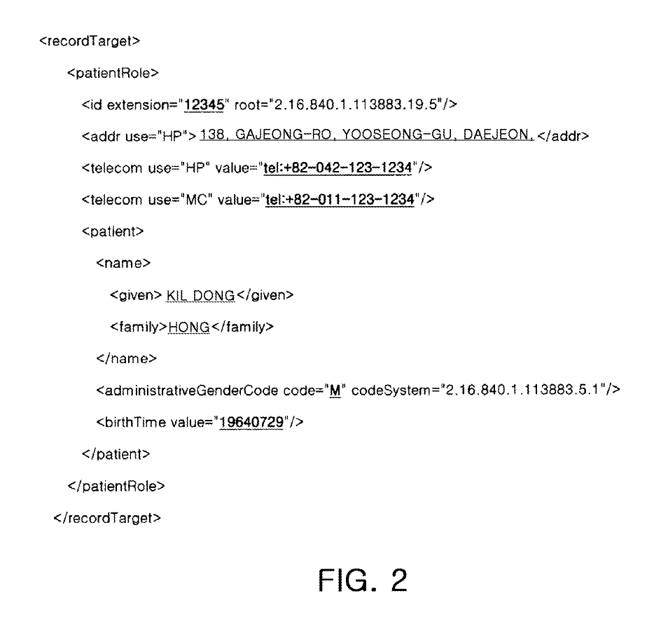

FIG. 2 illustrates an example of user information among header information extracted from the HL7 CDA document according to an exemplary embodiment of the present invention. The user information may include a personal health device user's ID, address, mobile phone number, home phone number, name, gender, date of birth, and the like.

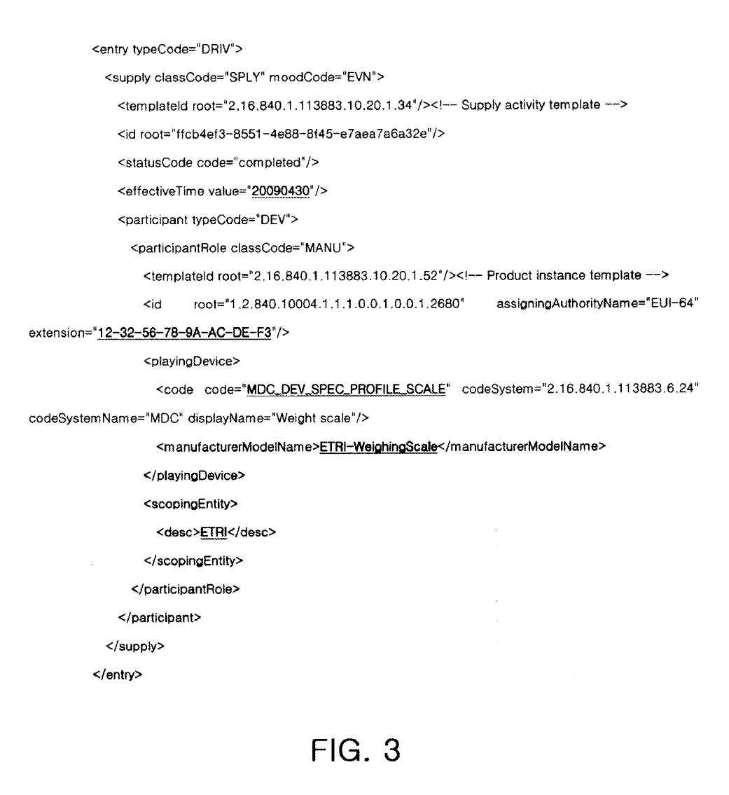

FIG. 3 illustrates an example of device information among header information extracted from the HL7 CDA document according to an exemplary embodiment of the present invention. The device information may include a type, a model, and the like, of a target personal health device.

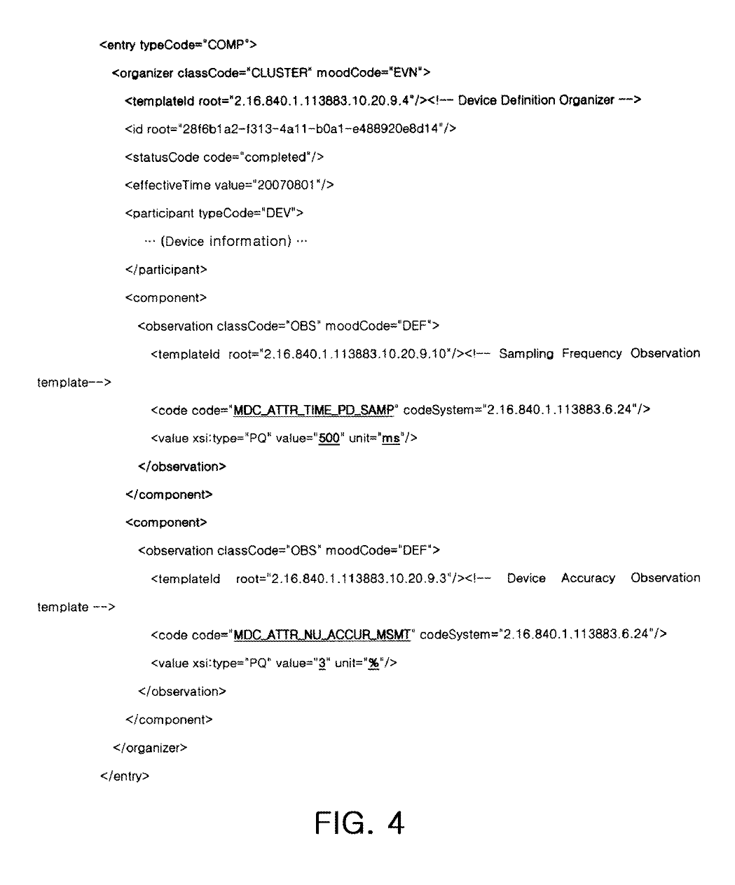

FIG. 4 illustrates an example of device supplementary information among header information extracted from the HL7 CDA document according to an exemplary embodiment of the present invention. The device supplementary information may include accuracy, sampling frequency, and the like, of the personal health device besides basic device information.

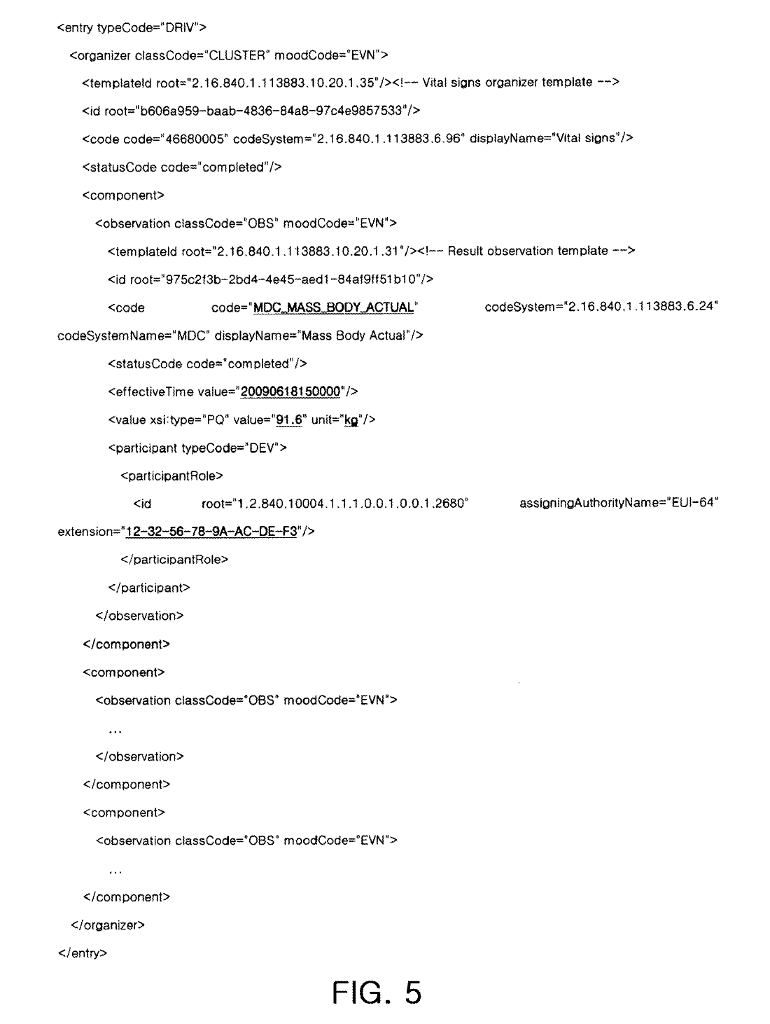

FIG. 5 illustrates an example of numeric data among health measurement information extracted from the HL7 CDA document according to an exemplary embodiment of the present invention. Numeric data includes data expressed by numeric values such as blood sugar level, blood pressure, weight, and the like among the measurement data of the personal health device. In this case, the measurement data of the personal health device is recorded in a vital sign section in the HL7 CDA document.

Meanwhile, a personal health device such as a blood pressure gauge measure several data such as a maximum blood pressure, a minimum blood pressure, an average blood pressure, and the like, through a measurement of one time. In this case, a plurality of measured pieces of data are arranged as several components in one observation. Also, the CDA analyzing unit 120 extracts measurement data of each component.

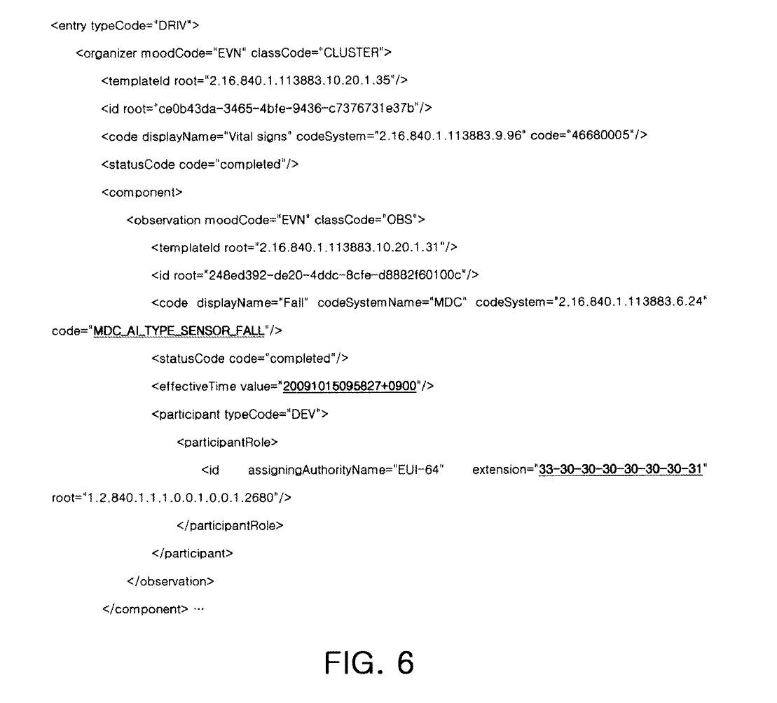

FIG. 6 illustrates an example of enumeration data among health measurement information extracted from the HL7 CDA document according to an exemplary embodiment of the present invention. The enumeration data refers to data expressing an event such as the occurrence of a fall, the taking of medicine, and the like. In the device CDA according to an exemplary embodiment of the present invention, a “Nomenclature code” value defined in the PHD standard is used as it is as per the enumeration data, and does not record a “value” value. For example, in the case of a fall, “MDC_AI_TYPE_SENSOR_FALL” is recorded as a code value and time is recorded as shown in FIG. 6.

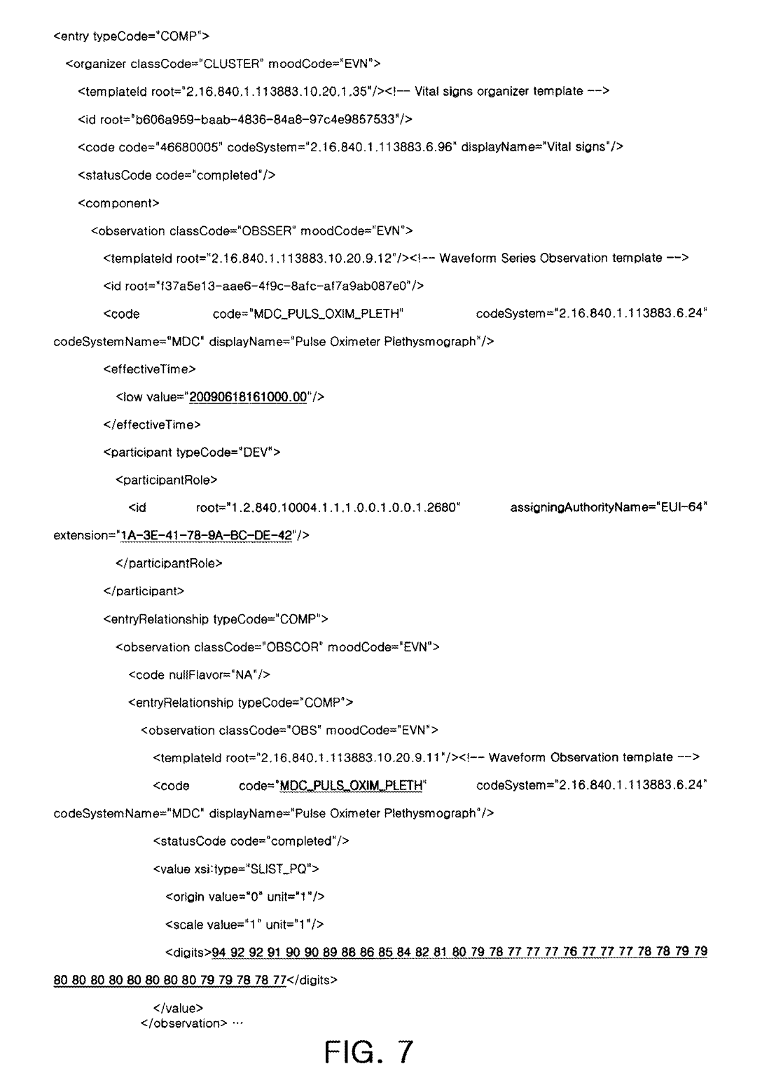

FIG. 7 illustrates an example of RT-SA data among health measurement information extracted from the HL7 CDA document according to an exemplary embodiment of the present invention. The RT-SA data includes array data for expressing waveform data, and as shown in FIG. 7, a code, time, a value list, and the like, of the waveform data can be extracted.

The user/device DB 131 stores the header information which has been extracted by the CDA analyzing unit 120, and in this case, the user/device DB 131 stores the corresponding information in the format of a user information table, a device information table, and a device attribute information table.

TABLE 1

| | | | | UNIQUE- |
|---|---|---|---|---|
| Column name | Type | Description | Length | NESS |
| USER_ID | VARCHAR | User ID | 20 | UNIQUE |
| | | (extension | | |
| | | attribute | | |
| | | of Id tag) | | |
| GENDER | VARCHAR | Gender | 10 | |
| GIVEN NAME | VARCHAR | Name | 20 | |
| FAMILY | VARCHAR | Family name | 20 | |
| NAME | | | | |
| ADDRESS | VARCHAR | Address | 100 | |
| HOME PHONE | VARCHAR | Phone number | 20 | |
| MOBILE | VARCHAR | Mobile | 20 | |
| PHONE | | phone number | | |
| BIRTH TIME | VARCHAR | Date of | 20 | |
| | | birth | | |

TABLE 2

| | | | | UNIQUE- |
|---|---|---|---|---|
| Column name | Type | Description | Length | NESS |
| DEVICE_ID | VARCHAR | Device ID | 30 | UNIQUE |
| | | (extension | | |
| | | attribute | | |
| | | of Id tag) | | |
| MODEL_NAME | VARCHAR | Manufacture | 50 | |
| | | model name | | |
| | | tag | | |
| SCOPING_ENTITY | VARCHAR | Scoping | 30 | |
| | | entity tag | | |
| DATE SUPPLY | VARCHAR | Effective | 20 | |
| | | time tag | | |
| CODE | VARCHAR | Code | 50 | |
| | | attribute | | |
| | | of code tag | | |
| | | of operating | | |
| | | device | | |

TABLE 3

| Column name | Type | Description | Length | UNIQUE |
|---|---|---|---|---|
| DEV_ATTR_KEY | VARCHAR | Unique key | 10 | UNIQUE |
| | | value of | | |
| | | measurement | | |
| | | data stored | | |
| | | in PHR DB | | |
| CODE | VARCHAR | Code | 50 | |
| | | attribute | | |
| | | of code tag | | |
| | | of observation | | |
| VALUE | VARCHAR | Measurement | 50 | |
| | | data | | |
| UNIT | VARCHAR | Unit of | 50 | |
| | | measurement | | |
| | | data | | |

PHR DB 132 stores health measurement information extracted by the CDA analyzing unit 120, namely, actual measurement data corresponding to a vital sign section of the device CDA. The PHR DB 132 stores numeric data, enumeration data, and RT-SA data in the format of the PHAR information table as shown in Table 4 below, as follows.

TABLE 4

| Column name | Type | Description | Length | UNIQUE |
|---|---|---|---|---|
| USER_ID | VARCHAR | User ID of | 25 | |
| | | corresponding | | |
| | | device CDA | | |
| DEVICE_ID | VARCHAR | Measurement | 50 | |
| | | device ID | | |
| | | (DEVICE ID | | |
| | | of device | | |
| | | information | | |
| | | table) | | |
| CODE | VARCHAR | Type of | 50 | |
| | | measurement | | |
| | | data | | |
| | | (Nomenclauter | | |
| | | code value) | | |
| EFFECTIVE | VARCHAR | Measurement | 50 | |
| TIME | | time | | |
| VALUE | VARCHAR | Measurement | 1024 | |
| | | data | | |
| UNIT | VARCHAR | Unit of | 50 | |
| | | measurement | | |
| | | data | | |
| DEV_ATTR_KEY | VARCHAR | Unique ID for | 10 | |
| | | device | | |
| | | attribute | | |
| | | information | | |
| | | table (in | | |
| | | case of RT-SA, | | |
| | | data exists) | | |

Data of every column, excluding DEV_ATTR_KEY column, is input as the numeric data. Data from columns, excluding VALUE, UNIT, DEV_ATTR_KEY columns, is input as the enumeration data. Data from every column, excluding UNIT column, is input as the RT-SA data. Attributes, such as accuracy, sampling frequency, and the like, of the measurement device are expressed through the device attribute information table.

Through such processing, every piece of personal health data measured by the user by using the personal health device can be effectively stored in the database.

When a request for a user's health history is received from a hospital, a public health center, a healthcare center, or the like, the health history check request processing unit 140 searches the user/device DB 131 and the PHR DB 132 and delivers searched information to the CDA merging unit 150. In this case, the health history check request processing unit 140 receives health history check request data, generates an SQL (Structured Query Language) statement on the basis of the received health history check request data, and searches the user/device DB 131 and the PHR DB 132. The health history check request data may include the following items.

User_ID: User ID

Device_ID: Device ID

From_Time: Start time

To_Time: End time

Code: Type of measurement data

With respect to the items of the health history check request data, it may be preconditioned such that User_ID is essential and the DB is searched when there is other item(s), and if there is no item, all the data is searched.

In this manner, because the user/device DB 131 and the PHR DB 132 proposed in the present exemplary embodiment classifies user, device, time, measurement data type, and the like, as independent columns, whereby a person's health history can be more effectively searched.

The CDA merging unit 150 configures a health history CDA document by using the information which has been delivered from the health history check request processing unit 140, and delivers the configured health history CDA document to the transmission unit 160. The health history CDA configuration process corresponds to a process of reversely processing the CDA analyzing process two times, details of which are as follows.

First, the CDA merging unit 150 configures a recordTarget tag by using user information retrieved from the user/device DB 131. In this case, if a value and tags, such as author, custodian, and the like, are required, those provided by the system are used.

Next, the CDA merging unit 150 reconfigures a medical equipment block by using device information retrieved from the user/device DB 131. In this case, if data is additionally required, a pre-set value in the system is used. Also, a narrative block regarding the medical equipment block is dynamically generated on the basis of reconfigured content.

Meanwhile, the health measurement information retrieved from the PHR DB 132 is reconfigured as a numeric block, an enumeration block, or an RT-SA block, depending on the type of the measurement data. In other words, when a value and a unit value exist in the retrieved information, the retrieved health measurement information is reconfigured as a numeric block. When the value and the unit value do not exist in the retrieved information, the retrieved health measurement information is reconfigured as an enumeration block. When the value is an arrangement of values, the retrieved health measurement information is reconfigured as the RT-SA block. In this case, a detailed block configuration method undergoes a reverse process of the data extracting process. Also, when data, such as templateID, display, and the like, is additionally required, values provided by the system are used.

As described above, the device CDA includes the results measured one time by one device, but the health history CDA includes results measured several times by a plurality of devices. Thus, in order to express the measurement data by the plurality of devices or data measured over several times, the blocks reconfigured through the foregoing process may be connected to configure a single health history CDA as follows.

For example, in case of numeric data, data measured at the same time by devices may be collected and configured as a bundle of several components within a single entry.

Also, entries configured thusly for respective devices may be arranged in order of measurement time to configure an entry row.

Entry rows configured to the respective devices may be arranged in certain order or pre-set order.

In addition, a narrative block regarding a vital sign section may be dynamically generated on the basis of content of an entry row.

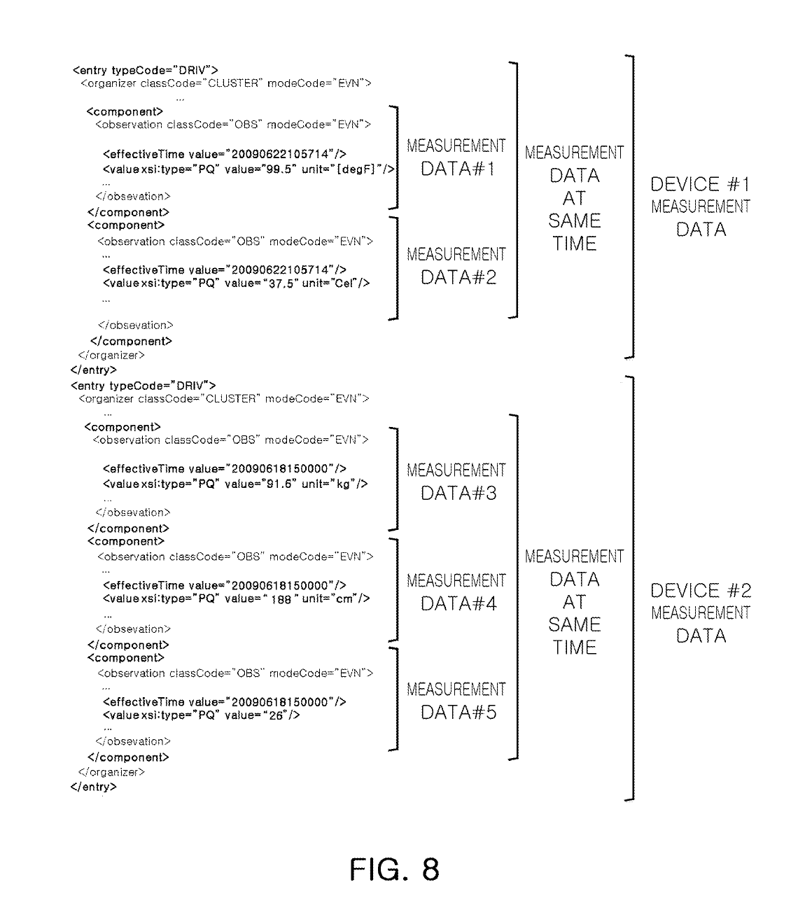

Through the foregoing process, a single health history CDA including a plurality of measurement data by device and by measurement time can be configured. FIG. 8 illustrates an example of a health history CDA configured according to an exemplary embodiment of the present invention.

The transmission unit 160 transmits the health history CDA document which has been configured by the CDA merging unit 150 to the hospital, the public health center, the healthcare center, or the like. In this case, the transmission unit 160 may transmit the health history CDA by using various communication protocols such as TCP/IP, MSMQ, Web service, or the like.

As set forth above, according to exemplary embodiments of the invention, because only measurement data, which is varied dynamically, can be extracted and stored, while maintaining the HL7 CDA template as it is, a storage space required for storing personal health data can be minimized, and thus, personal health data of a larger number of users can be effectively stored and managed.

In addition, the DB proposed in the exemplary embodiment of the present invention classifies user, device, time, measurement data type, and the like, as independent columns, whereby user's health history can be more effectively retrieved.

Also, when a health history check request is received from an external source, a plurality of health data retrieved from the DB is integrated as a single HL7 CDA document and provided, interworking with the external system that requires the user's health history can be facilitated.

While the present invention has been shown and described in connection with the exemplary embodiments, it will be apparent to those skilled in the art that modifications and variations can be made without departing from the spirit and scope of the invention as defined by the appended claims.

What is claimed is:

1. A system for managing personal health device measurement data based on HL7 CDA standard, the system comprising:
a reception unit receiving a device CDA(Clinical Document Architecture) from a health gateway;
a CDA analyzing unit analyzing the device CDA delivered from the reception unit to extract header information and health measurement information;
a user/device database (DB) storing the header information which has been extracted by the CDA analyzing unit; and
a personal health record (PHR) DB storing the health measurement information which has been extracted by the CDA analyzing unit.

2. The system of claim 1, further comprising:
a health history check request processing unit searching the user/device DB and the PHR DB according to a health history request received from the exterior;
a CDA merging unit configuring a health history CDA document by using search results delivered from the health history check request processing unit; and
a transmission unit providing the health history CDA, which has been configured by the CDA merging unit, to the exterior.

3. The system of claim 1, wherein the device CDA is personal health data which has been measured according to an ISO/IEEE 11073 PHD (Personal Health Device) international standard by a personal health device and then converted into an HL7 CDA format, which includes data measured once by one personal health device.

4. The system of claim 1, wherein the CDA analyzing unit extracts header information from computer processing blocks of a header and an entry of the device CDA and then extracts the health measurement information.

5. The system of claim 1, wherein the header information comprises user information and device information.

6. The system of claim 1, wherein the health measurement information is divided into numeric data expressed as a numeric value, enumeration data expressing an event, and an RT-SA (RealTime-SampleArray) data expressing waveform data according to measurement data by a personal health device.

7. The system of claim 1, wherein the user/device DB stores the header information in the format of a user information table, a device information table, and a device attribute information table.

8. The system of claim 7, wherein the user information table comprises any one or more of a USER ID column storing a user ID, a GENDER column storing the gender of a user, a GIVENNAME column storing a user's name, a FAMILYNAME column storing a user's family name, an ADDRESS column storing a user's address, a HOME_PHONE column storing a user's phone number, a MOBILE_PHONE column storing a user's mobile phone number, and a BIRTH_TIME column storing a user's birth date.

9. The system of claim 1, wherein the device information table comprises any one or more of a DEVICE_ID column storing an ID of a personal health device, a MODEL_NAME column storing a model name of a maker of the personal health device, a SCOPING_ENTITY column storing a scoping entity tag, a DATE SUPPLY column storing an effective time tag, and a CODE column storing a code attribute of a code tag of the personal health device.

10. The system of claim 7, wherein the device attribute information table comprises any one or more of a DEV_ATTR_KEY column storing a key value of measurement data stored in the PHR DB, a CODE column storing a code attribute of a code tag of observation, a VALUE column storing measurement data, and a UNIT column storing the unit of the measurement data.

11. The system of claim 1, wherein the PHR DB stores the health measurement information in the format of a PHR information table.

12. The system of claim 1, wherein the PHR information table comprises any one or more of a USER_ID column storing a user ID of a device CDA, a DEVICE_ID column storing an ID of a personal health device, a CODE column storing the type of measurement data, an EFFECTIVE_TIME column storing a measurement time, a VALUE column storing measurement data, a UNIT column storing the unit of the measurement data, and a DEV_ATTR_KEY column storing a specific ID for a device attributer information table.

13. The system of claim 12, wherein, in the PHR information table, data of every column excluding the DEV_ATTR_KEY column is input as the numeric data among the health measurement information, data of the columns excluding the VALUE column, the UNIT column, and the DEV_ATTR_KEY column is input as the enumeration data, and data of every column excluding the UNIT column is input as the RT-SA data.

14. The system of claim 13, wherein, in the PHR information table, the accuracy and sampling frequency of the personal health device is expressed through the device attribute information table by using the DEV_ATTR_KEY column.

15. The system of claim 2, wherein the health history check request processing unit generates an SQL (Structured Query Language) statement on the basis of health history check request data received from an external source and search the user device DB and the PHR DB.

16. The system of claim 15, wherein the health history check request data comprises any one or more of a user ID, a device ID, a start time, an end time, and a measurement data type item.

17. The system of claim 2, wherein the CDA merging unit configures a recordTarget tag by using user information retrieved from the user/device DB, reconfigure a medical equipment block by using device information retrieved from the user/device DB, and dynamically generate a narrative block of the medical equipment block on the basis of the reconfigured content.

18. The system of claim 17, wherein when the health measurement information retrieved from the PHR DB has a value and unit value, the CDA merging unit reconfigures a numeric block, when the health measurement information retrieved from the PHR DB does not have the value and unit value, the CDA merging unit reconfigures an enumeration block, and when the value is an arrangement of values, the CDA merging unit reconfigures an RT-SA block.

19. The system of claim 18, wherein the health history CDA configured by the CDA merging unit comprises data measured several times by a plurality of personal health devices.

20. The system of claim 19, wherein the CDA merging unit collects data which has been measured at the same time by personal health devices to configure the same as a bundle of a plurality of components in a single entry, arranges a plurality of entries configured by collecting data measured at the same time with respect to respective personal health devices in order of measurement time to configure an entry column, arranges entry columns configured by personal health device in random order, and dynamically generates a narrative block with respect to a vital sign section on the basis of content of the entry column, thus configuring the health history CDA.
